(19) United States
(12) Patent Application Publication
(10) Pub. No.: US 2019/0347743 A1
(43) Pub. Date: Nov. 14, 2019

(54) SYSTEM AND METHOD FOR SOCIAL NETWORK ORDERING OF GOODS OR SERVICES

(71) Applicants: Juan Diego Ponce, Hollywood, FL (US); Juan Sebastian Vinelli Ayala, Hollywood, FL (US)

(72) Inventors: Juan Diego Ponce, Hollywood, FL (US); Juan Sebastian Vinelli Ayala, Hollywood, FL (US)

(21) Appl. No.: 16/405,560

(22) Filed: May 7, 2019

Related U.S. Application Data
(60) Provisional application No. 62/668,804, filed on May 8, 2018.

(51) Int. Cl. G06Q 50/00; G06Q 30/06; G06Q 10/08

(52) U.S. Cl. CPC G06Q 50/01; G06Q 10/083; G06Q 30/0641

(57) ABSTRACT

A system and method for social network ordering, the computer implemented method providing a way for users to purchase goods or services for themselves or another user at various establishments that the users have “checked in” into as well as to send funds that may be used in social network ordering application. The method may also allow users to communicate with other users as well as purchase goods or services for other users if the user are at the same establishment.

### CROSS-REFERENCE TO RELATED APPLICATIONS

This application claims priority to a prior-filed provisional application Ser. No. 62/668,804 filed on May 8, 2018.

### FIELD OF DISCLOSURE

The overall field of this invention is a system and method for ordering goods and services, and more particularly, a system and method for placing, processing, and transmitting orders for remotely ordered goods and services to an establishment to be delivered to a user by another user connected over a communications network.

### BACKGROUND

People, now more than ever, are connected to each other through technology. Families and friends scattered across the world can interact with one another through phone calls, video chat, and texting. This phenomenon has become a double-edged sword in that people are more interested in staying connected with others over social media and no longer interact with those located immediately around them. This can be seen at any public gathering with people predominately focused on their mobile devices only looking up to show others what they are currently reading or watching on their mobile device.

Currently, there are many remote ordering systems available that allow a person to place an order for goods or services over their mobile device, but usually only for themselves. Typically, they are designed for users lounging at home looking through the menu of a restaurant out of walking distance or who just do not have the energy or time to make the trip to the restaurant or other establishment. The user can then select what they want off of the menu for a fee and using their payment information can order the food remotely. Once ordered, a message is sent to the restaurant to make the user's order and a notification to a driver to pick up that order when the restaurant is done making it. The driver then can deliver the order to the user's house for the user to enjoy. Additionally, these applications are used in the restaurant and grocery business for delivery purposes.

There are multiple social media networks and applications where people interact with each other through their mobile devices or computers. Users can post on each other's social media accounts while trading stories or pictures from the past as well as information about future events. Users may also share links and pictures with one another as well as comment on the links and pictures to share memorable moments, strike up a discussion, or even to debate current issues. Users can also communicate with one another through a messaging system in order to otherwise stay in touch.

However, these applications do not solve the problem of people not interacting with those in the immediate area around them and do not provide a way for business and patrons to send and order goods and services in an easy and accessible manner. Thus, there still exists a great need for an improved process and system for mobile ordering. In particular it would be helpful to have an application where you can remotely purchase goods and services for another user using their geographic location and specific preferences. An additional component would be that the goods and services may be shared with others in the same location, which helps to facilitate direct human interaction.

### BRIEF DESCRIPTION OF DRAWINGS

The overall field of this invention is a system and method for ordering goods and services, and more particularly, a system and method for placing, processing, and transmitting orders for remotely ordered goods and services to an establishment to be delivered to a user by another user connected over a communications network.

The present invention will be described by way of exemplary embodiments, but not limitations, illustrated in the accompanying drawings in which like references denote similar elements, and in which:

FIG. 1 depicts a schematic diagram of a social networking ordering system according to an illustrative embodiment.

FIG. 2 depicts an example of a user ordering goods or services for another user checked into an establishment according to an illustrative embodiment.

FIG. 3 is a flow diagram depicting a method for selecting; a participant and delivering an order using the social networking system of FIG. 1 according to an illustrative embodiment.

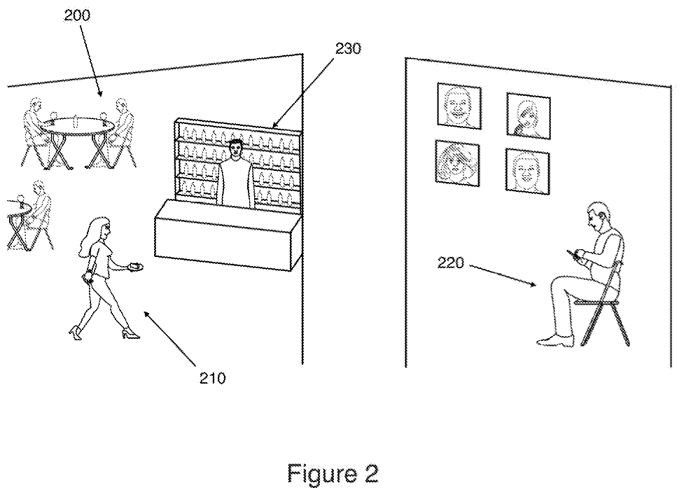

FIG. 2 depicts an example of a user ordering goods or services for another user checked into an establishment according to an illustrative embodiment.

FIG. 4 depicts an example of a user ordering goods or services for another user checked into an establishment and communicating with the other user through a social network ordering application according to an illustrative embodiment.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items,” may indicate the presence of only one item, or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skill in the art that the invention may be practiced without these specific details. In other instances, well-known features have not been described in detail to avoid unnecessarily complicating the description.

The present disclosure recognizes the unsolved need for an improved system and method for a social networking ordering system particularly an application where a first user may remotely purchase goods and services for a second user at a particular establishment or location wherein the first user and second user are connected as contacts on a social media application that notifies or alerts the other as to each other's location. One of the many objectives of the present embodiments is that shared users can interact and connect with another in a pleasant manner via social media networking, such as enabling a first user to order and deliver from a remote or same location as a second user one or more desirable goods and/or services. There are many possible applications of the one or more embodiments described herein. In particular, using this application, a user can buy goods and services for other users connected through one or more social media sites. Such users may also be contacts found in their mobile contacts list or address book that may be integrated into a social media ordering application described in one or more embodiments herein. Additionally, it may be convenient for a user to buy goods or services through the social medial ordering application to order items in advance of arriving at a location or instead of waiting for a bartender in crowded lines to start a tab or awaiting service from a waiter or instructor.

In particular, users may also purchase goods and services for other users (e.g. friends or family or acquaintances) who have “checked in” to an establishment, whether or not the users are located in the same location as each other. Rather, one user will be notified of the location of the other and has the option to order desirable goods or services as a gift or kind act for the other user who is checked in at the establishment. Checking-in is a process that identifies a user with a particular establishment at a given time. Users may also communicate with each other through the application if the users are at the same establishment or venue. Further details are provided below along with the description of the accompanying Figures.

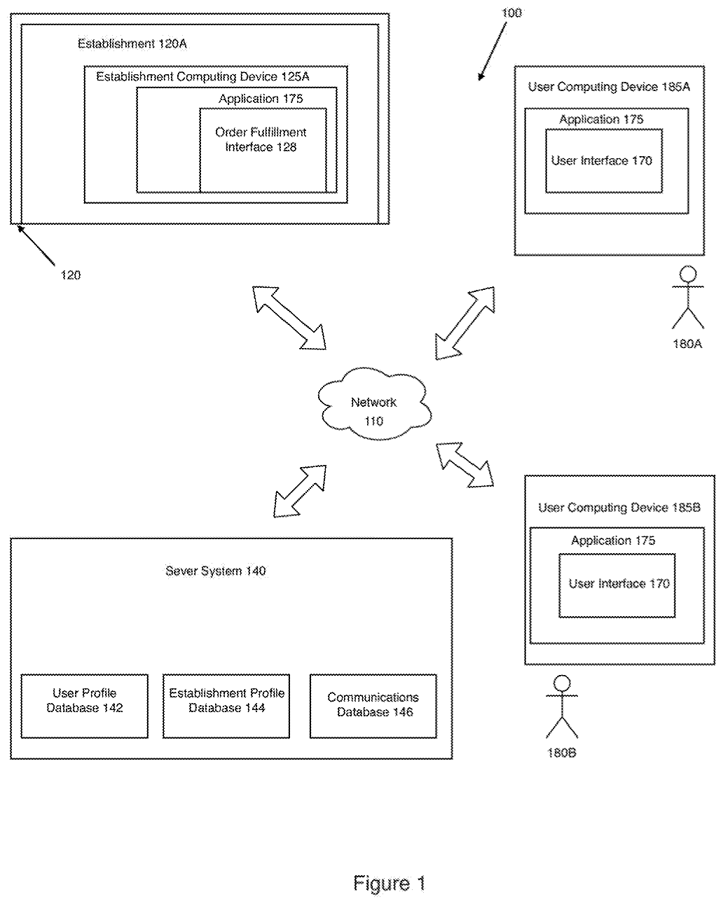

Turning to FIG. 1, FIG. 1 depicts a block diagram of an embodiment of the present invention for social networking ordering system 100. Social networking ordering system 100 may include a plurality of establishments such as establishments 120. Establishments may be locations where users, such as users 180a and 180b, may place an order. An order may be a request for one or more goods or services. For example, goods may include but are not limited to a drink or meal and services may be but are not limited to a massage or dancing lesson, which is placed in connection with the purchase of the goods or service. Any type of establishment offering any type of goods or services may be available. Further, establishments 120 may be located in various geographical locations that are either located apart or are located in proximity to each other.

Establishments 120 may provide for an assortment of unique and diverse selections for users 180 to select from. An order placed by users 180a and 180b may be processed by one or more user computing devices such as user computing devices 185 (which may include user computing devices 185a and 185b), one or more servers such as server 140, and an establishment computing device such as establishment computing device 125. The various components listed above may be interconnected via a network such as network 110.

Continuing with social network ordering system 100, establishment computing device 125, user computing devices 185, and server(s) 140 may all be communicatively connected to network 110. In one or more embodiments, network 110 may include a local area network (LAN), such as a company Intranet, a metropolitan area network (MAN), or a wide area network (WAN), such as the Internet or World Wide Web. Network 110 may be a private network or a public network, or a combination thereof. Network 110 may be any type of network known in the art, including telecommunications network, a wireless network (including Wi-Fi), and a wireline network. Network 110 may include mobile telephone networks utilizing any protocol or protocols used to communicate among establishment computing device 125 AND user computing devices 185, such as GSM, GPRS, UMTS, AMPS, TDMA, or CDMA. In some embodiments, different type of data may be transmitted via network 110 via different protocols.

Network 110 may further include a system of terminals, gateways, and routers. Network 110 may employ one or more cellular access technologies including 2nd (2G), 3rd (3G), 4th (4G), 5th (5G), LTE, Global System for Mobil communication (GSM), General Packet Radio Services (GPRS), Enhanced Data GSM Environment (EDGE), and other access technologies that may provide for broader coverage between computing devices and establishment computing devices if for instance they are in a remote location not accessible by other networks.

User computing devices 185 (which may include user computing devices 185a and 185b) and establishment computing device 125 may be any type of computing device known to those of ordinary skill in the art. User computing devices 185 are preferably mobile computing devices such as an iPhone, Android-based phone, or Windows-based phone and establishment computing device is preferably a tablet, however, this is non-limiting and these computing devices may be a computing device such as a phone, tablet, desktop computer, laptop computer, video game console, wearable device, or smart home device, which are able to connect to network 110 and to retrieve data for placing an order.

User computing devices 185 and establishment computing device 125 may include any number of components operatively connected in a computing device, including, without limitation, a processor, a memory, and communication component such as an antenna and communication interface for wireless communications, one or more input and/or output (I/O) components and/or interfaces, and one or more sensors. User computing devices 185 and establishment computing device 125 may include a touchscreen for displaying data to users 180a and 180b as well as receiving input from users 180a and 180b. In other embodiments, other types of input entry devices may alternatively or additionally be used including a mouse, keyboard, and/or stylus. In further embodiments, user computing devices 185 and establishment computing device 125 may include voice recognition capable software that may be used to navigate or issue instructions.

User computing devices 185a and 185b and establishment computing device 125 may have a camera having any type of image capture device for capturing an image. For example, the camera may be a color and depth camera, a webcam, a 3D camera, or any other type of image capture device. The image may be captured and stored as image data. The image data may include photographs and/or videos. The camera may have a communication interface to communicate with the computing device to exchange image data and may transfer the image data to the computing device. User computing devices 185 and establishment computing device 125 may have location tracking capabilities such as Mobile Location Determination System (MLDS) or Global Positioning System (GPS) whereby the computing devices may include one or more satellite radios capable of determining the geographical location of the computing devices. User computing devices 185 and establishment computing device 125 may utilize GPS to confirm the validity of location information.

A user interface, such as user interface 170, and order fulfillment interface, such order fulfillment interface 128, may be displayed on a social network ordering application such as social network ordering application 175. User interface 170 may be included with social network ordering application 175. Social network ordering application 175 may be downloadable and installable on user computing devices 185 and establishment computing device. In some embodiments, social network ordering application 175 may be preinstalled on user computing devices 185 and establishment computing devices 125 by the manufacturer or designer. Further, social network ordering application 175 may be implemented using a web browser via a browser extension or plugin.

Users 180a and 180b and/or authorized agents of establishments 120 may initially start a session by launching social network ordering application 175 on user computing devices 185 and establishment computing device 125. In other embodiments, users 180a and 180b and establishments 120 may initially commence a session by going to a predefined website address or domain name. In other embodiments, user computing devices 185 or establishment computing device 125 may have social network ordering application 175 already downloaded onto the computing devices used by users 180a and 180b or agents of establishments computing device 125.

Social networking ordering system 100 may operate on one or more servers located at an establishment, such as establishment 120, remote data center, or any other location suitable for providing service to a network. Server 140 may comprise a database server such as MySQL® or Maria DB® server. Social networking ordering system 100 may be distributed across multiple servers that may be in the same location or different locations in any arrangement. Server 140 may have several databases, including a database for storing data for users' profiles such as user profile database 142, establishment profiles such as establishment profile database 144, and communication between users such as communications database 146.

Server 140 may comprise a number of modules that provide various functions related to social network ordering system 100 using one or more computing devices similar to user computing devices 185 and establishment computing devices 125. Modules may be in the form of software or computer programs that interact with the operating system of server 140 whereby data collected in databases, may be processed by one or more processors within server 140 or another component of social network ordering system 100 as well as in conjunction with execution of one or more other computer programs.

Modules may be configured to receive commands or requests from user computing devices 185 and establishment computing devices 125 and communicate appropriate responses to requesting user computing devices 185 and establishment computing devices 125. Server 140 may receive one or more orders initiated by users 180a and 180b via user interface 170 on social networking application 175 running on user computing devices 185.

After receiving the order from user computing devices 185, the order may be transmitted (e.g. via server(s) 140) to establishment computing device 125 of establishments 120 as well as to multiple other user computing devices 185 or any other devices connected on network 110. Establishment computing device 125 may display the order through order-fulfillment interface 128 whereby an employee, member, or staff may then carry out the order or delegate the order to the one responsible for carrying out a task such as the specific employee needed to fulfill the order. One or more menu selections and cancellation requests initiated by establishments 120 on the order-fulfillment interface 128 may be displayed on establishment computing device 125. In one embodiment, a verification code, voucher redemption code, validation or authentication information may be presented through user interface 170 to users 180a and 180b who may then redeem the order either before or after establishments 120 has started or completed the order for users 180a and 180b.

Turning to FIG. 2, FIG. 2 provides a pictorial illustration of an exemplary scenario illustrating the above described exemplary system and method for using social ordering network application 175 and the various components described above. Claire 210 lives in a large metropolitan city with her brother Cameron 220 and is planning on celebrating her 22nd birthday by going to an Italian restaurant called “Taste of Italy.” Cameron 220 had to travel out of town for a last minute work meeting and cannot make it to Claire's 210 birthday party. Claire 210 launches the social network ordering application and “checks in” to the establishment “Taste of Italy” 200 using her smartphone while at the location or in advance at another location. Cameron 220 knowing Claire 210 loves red velvet cake decides to order a slice of red velvet cake to be delivered to Claire 210 at the establishment via an online ordering system at which they are preregistered.

Cameron 220, using his smartphone, launches social network ordering application 175 and selects Claire's 210 name seeing that she is at “Taste of Italy” 200. The social network ordering application presents a menu of “Taste of Italy” 200 where Cameron 220 selects a slice of red velvet cake and adds the cake to the shopping cart. Cameron 220 checks out and puts in the necessary payment using his credit card and adds a message to be sent to Claire 210. In this way, Cameron 220 advantageously is able to purchase goods (e.g. the red velvet cake) for his sister Claire 210 to celebrate the occasion and have the goods delivered to her in a timely way on her actual birthday while Claire 210 is at the restaurant 200 and in honor of her birthday.

Claire 210 receives a notification on her smartphone that Cameron 220 has ordered her a red velvet cake along with a happy birthday message and color sequence, such as, for example, Orange Blue Purple Yellow Green. Claire 210 is notified that the slice of red velvet cake will be available in three (3) minutes. The waiter, Chuck 220 receives notification on the “Taste of Italy” 200 workstation tablet for Claire 210 and may be redeemed using the code Orange Blue Purple Yellow Green. Chuck 220 grabs a piece of red velvet cake behind the dessert counter. Claire 210 presents her code of Orange Blue Purple Yellow Green to Chuck 220 who verifies that this does indeed match with his redemption code and delivers the slice to Claire 210. Chuck 220, Claire 210, and Cameron 220 receive notification that this order has been completed. Claire 210 is later given a survey on the social network ordering application asking about the slice of red velvet cake, which she writes that she very much enjoyed.

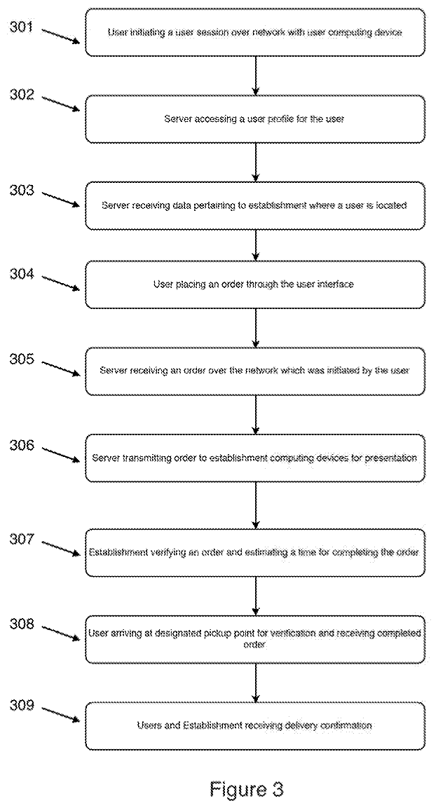

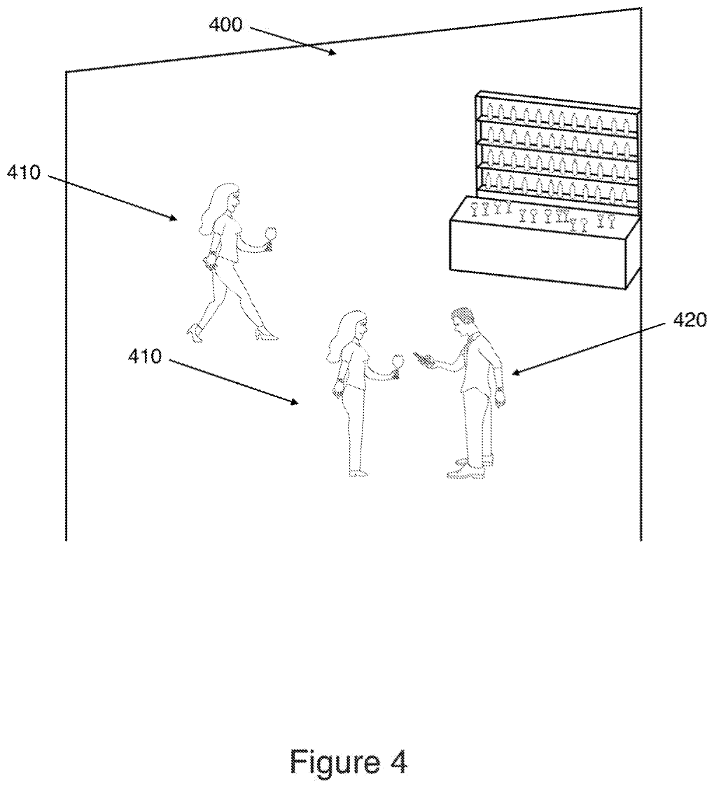

Turning to FIG. 3, FIG. 3 depicts a flow diagram showing an embodiment of an exemplary method for implementing social network ordering system 100. One or more components included in FIG. 1, such as, without limitation, user computing devices 185a and 185b, establishment computing device 125, network 110, user computing device 185a that is then displayed on an establishment computing device 125 through an order fulfillment interface 128. Establishments 120 may then complete the order whereby user 180b on user computing device 185b may verify and receive the order. Further, one or more exemplary method steps may be performed by social networking ordering system 100 including server 140, user computing devices 185a and 185b, and establishment computing device 125, which may be interconnected via network 110.

Establishments 120 may initially register to become a registered establishment associated with social network ordering application 175, such that its goods and services may be available to other users (e.g. users 180a and 180b) to order either on site or remotely either for themselves or for another contact with access to social network ordering application 175. Upon initially signing up with social network ordering application 175, establishments 120 may be prompted to provide information along with a requested password. Information may be the hours, directions, promotional content, contact information, corporate structure, and reservations of establishment 120. When registering with social network ordering application 175, establishments 120 may also be able to log into social network ordering application 175 using login credentials from other social networking platforms, such as, for example, logging in with a Yelp® profile.

Order fulfillment interface 128, shown in FIG. 1, may provide information and options for establishments 120 to input relevant information associated with its goods and services, including, without limitations, images related to goods and/or services, available selections, quantity, and/or promotional material that may be viewed by other users (e.g. users 180a and 180b). In other embodiments, a developer or designer may input an unique establishment 120 profile into establishment profile database 144 for connecting with users 180a and 180b and receiving order information.

Selections such as goods and services may be uploaded from establishment computing device 125 by staff or employees of establishment 120 to establishment profile database 144. An updated list of selections provided by establishment 120 may be inputted manually through order fulfillment interface 128 by staff or employees to the establishment profile database 144 or establishment computing device 125 may connect to an available establishment inventory system to provide information about available goods and or services selections. For example, if establishment 120 provides food and wants to include relevant portions or all of its menu, establishment 120 may include selections currently available based on the time of day (such as food only available during brunch and food only available during dinner) among other inputs such as current product inventory to assure that all the necessary ingredients are available before allowing it to be uploaded to the menu. In some embodiments, if particular goods or services are available but not a specific ingredient (such as a tomato in a cheeseburger) the goods or services may still be uploaded to the menu, however the unavailable component would not be included in the list of possible choices.

At step 301, a method may include a user, such as user 180b initiating a session over network 110 with user computing device 18b. The session may be initially started by user 180b launching and running social network ordering application 175 on user computing device 185b installed by user 180b through a manufacturer prescribed process such as downloading social network ordering application 175 from an application store or social network ordering application 175 may be preinstalled by the manufacturer or designer. In some embodiments, users 180 may navigate to a specific web address to initiate a session.

At step 302, the method may include accessing a user profile for user 180b. In one embodiment, the user profile may reside in user profile database 142 on server 140, which may be accessed and referenced using an identifier provided by user 180b as part of the registration process or login process such as an account name and password.

When user 180b initially registers to become a registered user of social network ordering application 175, user 180b may be prompted to provide some personal information along with a requested account name and password, such as, without limitation, his or her name, age (e.g., birth date), gender, interests, contact information, home town, address, preferences of food, favorites establishments, skills, professional organizations, or relationship status. In some embodiments, when registering a user account, social network ordering application 175 may allow user 180b to access and interact with social network ordering application 175 using login credentials from other social networking platforms. For example, in some embodiments, it may be useful and convenient for users of social network ordering application 175 to be able to log in using credentials or sign in information from another social media application, such as Facebook® or Instagram ® or the like. This is advantageous for users who do not wish to have to learn or provide multiple login information.

User 180b may be requested to take pictures of themselves whereby server 140 collects and stores pictures of each user in user profile database 142 to display to other users through user interface 170. Pictures may be for identification purposes during navigation of a session and to enhance the authenticity of the process by ensuring that the picture is of the correct, intended user when ordering goods or services. User 180b may couple, link, or connect with user accounts from social networking websites and internal networks. Examples of social networking websites include but are not limited to Instagram®, Facebook®, LinkedIn®, Snapchat®, and Twitter®. Server 140 may use access tokens or other method as a parameter for searching for a friend list or address book of user 180b on a social networking site or other site. Server 140 then may use this friend list information to initialize a contact list database for users 180 stored within user profile database 142.

At step 303, the exemplary method may include server 140 receiving data pertaining to the specific establishment 120a where user 180b is located. Server 140 may send a data request to user computing device 185b, displayed through the user interface 170, for identifying a geographic location of user computing device 185b or a network location of user computing device 185b, as well as a timestamp identifying when the request was transmitted to user computing device 185b. The geographic location may be any physical location, which may be expressed in longitudinal and latitudinal coordinates, and may include other dimensions and factors such as altitude or height for determining an exact position of the geographic location.

In other embodiments, user 180b may input zip codes, city, county, state names, landmarks or other important locations through the user interface 170 to identify the geographical location of user computing device 185b. User interface 170 may display all available establishments 120 registered and stored within server 140 that are in the general area or in near proximity to user's 180b geographic location. In one or more embodiments, establishments 120 may be displayed on a map. The map may be displayed to user 180b with establishments 120 displayed as markers, pins, or identifiers at their respective geographic locations.

Establishments 120 may also be displayed through a list or a drop-down menu from which a user (such as user 180b) may be able to select. Accordingly, user 180b may select the establishment where user 180b is currently located. In some embodiments, the closest establishment 120 in proximity to user's 180b geographic location may be displayed, and in further embodiments, the closest establishment 120a in proximity to user's 180b geographic location may be automatically selected if user 180b remains at that location for a set amount of time. User interface 170 may selectively enable location tracking while social network ordering application 175 is running or even as long as user computing device 185b is powered on.

The user profile for user 180b may be associated with an establishment's 120a social networking system such as a loyalty program account. A loyalty program account may provide various points and benefits that translate to savings and other desirable incentives for a user that is part of the loyalty program account. This may be done by swiping a loyalty card at establishment 120a at establishment computing device 125 or other suitable device that is able to connect to server 140 on network 110 to “check in” user 180b at the establishment 120a.

In some embodiments, user 180b may search for a specific establishment 120 using a name or category to locate a nearby establishment. For example, a search request having a character string may be entered whereby one or more establishments may be identified using name, type of goods and/or services provided, or other metadata. Further, a closest establishment matching the search request may be provided that is located within some threshold distance of the user's current geographic location. For example, if user 180b wants to locate a nearby pizza restaurant for ordering its goods and services associated with social media network application 175, user 180b may type “pizza” with a search request through user interface 170. Server 140 may access establishment profile database 144 and return a list of nearby pizza stores shops. In another example, if user 180b wants to locate a tavern named “Charlie' s” for ordering its offered goods and services associated with social media network application 175, user 180b can type “Charlie's” with a search request through user interface 170. Accordingly, a list of nearby taverns named “Charlie's” may be provided to the user in response to his or her search.

User 180b may input additional text or changes to the existing search request through user interface 170 to receive an updated list of establishments based on the newly entered text. The search request may also include other parameters, such as categories, price, distance, already visited establishments, and/or establishment hours. Further, in some embodiments, these parameters as well as others may be automatically factored in when a search request is conducted. User interface 170 may provide the ability to adjust and select parameters that may be used to filter and/or rank the results of the establishments displayed to the user 180b.

A “check in” as used herein is self reported positioning of users 180 at a physical place and share their locations with their friends or other contacts. In some embodiments users 180 must be at the physical location while in other non limiting embodiments user may check in to any establishment from any location. User's 180b “check-in” may also be recorded and uploaded to user profile database 142 of server 140 whereby the “check-in” may be transmitted to other user computing devices 185 where user interface 170 displays the “check in” of user 180b and recent activity to the user's 180b social contacts. Server 140 may also store user's 180b check-in in user profile database 142 for subsequent use and collection of information pertaining to user 180b. In some non-limiting embodiments, user's 180b “check in” is visible to user's 180b contacts and even other non-contact users depending on privacy settings, which may be set or modified by user 180b via the user interface 170. In further embodiments user 180b may view selections of establishments 120 through user interface 170 and select a good or service they wish to receive which then may be stored in user profile database 144 and presented to user 180a.

At step 304, the exemplary method may include user 180a initiating a session on social networking ordering application 175 on user computing device 185a in a similar method to user 180b as previously discussed and placing an order through user interface 170. The order may indicate one or more goods and/or services from establishment 120a. User interface 170 may display a list of contacts including user 180b that have “checked in” into establishment 120a. The contacts may be displayed on a map. The map may be displayed to user 180a with the contact displayed as markers, pins, or identifiers at their respective establishments. Contacts may also be displayed on user interface 170 as a list or a drop-down menu. The list may display all contacts of users 180 and show contacts in different ways that may be differentiated by numerous parameters, such as contacts who are “checked in” into an establishment such as establishment 120a, contacts such as user 180b who are currently using the social networking ordering application 175, and contacts who are offline. If desired, user 180a may select a contact such as user 180b that has “checked in” into an establishment such as establishment 120a. In some embodiments, user 180a may select multiple contacts that have “checked in” into to the same establishment.

Once a contact has been selected by user 180a, such as, for example, selecting user 180b, user interface 170 allows user 180a to browse and select goods or services provided as possible selections that are associated with the establishment's profile that may be stored in establishment profile database 142 as well as view one or more favorites selected by user 180b. These selections may be displayed through a list or a drop down menu on user interface 170 of user 180a's social media network application 175 located on user computing device 185a.

To place an order, a user may select a particular set of goods and or services either for him or her or for another user. Selections may have nested hyperlinks for linking and to provide additional details to learn about the goods or services. For example, an available menu of choices may have a selection for bourbon based drinks with a list of the different bourbon drinks such as an old fashioned, Manhattan, mint julep, whiskey sour, boulevardier with a picture and price next to the name. By selecting the name, picture or price, the menu would provide additional information on that selection including a larger image with details.

Menu assortment may be simplified to facilitate the selection of goods and services by filtering options provided through user interface 170. The selected filter category may cause the menu list to only display selections from the selected category, such as only drinks or gluten free foods. Optionally, establishment's 120 operators may choose to define promotional items that can be displayed at the top of the menu. Further, previous selections chosen by user 180a can be retained in the server database and displayed at the top of the menu. In some embodiments, menu options may be displayed to user 180a based upon information collected by server 140 and stored in user profile database 142, such as price range, contact preferences and allergies, and demographics, to intelligently present the menu and provide selections that would be appealing to the user.

User interface 170 may provide user 180a the option to select if user 180a wants the order to be processed and delivered immediately or, alternatively, provide the option for the user to select a particular date and time for the order to be delivered to establishment 120a. Accordingly, it may be possible for a user to place an order in advance, in which case the order is placed in a pre-order list until the designated time. The pre-order list may be modified or cancelled before the order has been processed. User interface 170 may enable user 180a to select multiple contacts and assign the different selections to the contacts in order to simplify a multi-contact order.

User interface 170 may provide additional information on the selections to user 180a such as if they ordered this item in the past and if so be how many times they ordered the item. User interface 170 may enable user 180a to customize the selection after being selected by providing by a series of lists or drop-down choices from which the user 180a may select. Fields may also be provided to user 180a for inputting special instructions regarding user preferences for cooking, seasoning, and allergy information.

User 180a may add selections to their order or return to a previous menu to continue to search for other goods and services. If user 180a chooses to select a particular set of goods and/or services and to place an order, user 180a may be returned to the menu to continue the process of selecting other selections. Once one or more selections have been chosen, the selections are placed in a shopping cart and the selections appear in the order list. As selections are added to the order list, a sub-total is calculated.

If satisfied with the order of the shopping cart, user 180a may proceed to checkout using an appropriate button. If user 180a is not satisfied, they may cancel one or more specific selections or orders in the order list or modify a selection, returning user 180a to a previously engaged menu session to alter the selection.

User interface 170 may display to user 180a the final order summary, the price information including subtotal, discounts and taxes, promotional coupon and gift card entry fields, gratuity or tipping field, mode of payment, and calculated total including subtotal combined with taxes, discounts, and gratuity added. User 180a may input their credit card information for a credit card using any credit card known in the art, including, without limitation an ATM card, a VISA®, MasterCard®, Discover®, or American Express® card in a credit card input field, or can alternatively use PayPal® or the like. User 180a may submit the payment information via an appropriate button through user interface 170 or return to an earlier step in the session.

User interface 170 may provide the ability to obtain one or more images of the credit card associated with the financial transaction. Images of the credit card may be captured by camera on user computing device 185a wherein social network ordering application 175 may have access to the images. Images may include a front image of the credit card and back image of the credit card. Sever 140 may collect and store pictures of one or more credit cards of each user in user profile database 142 for subsequent use. In some embodiments, images and the extracted details of the credit card may be deleted from the memory immediately or shortly after a transaction has been completed or terminated, while in further embodiments temporarily stored credit card data may be encrypted and compressed for added security and stored on user profile database 142 for subsequent use whereby user interface 170 may allow user 180a to select from previously used credit cards.

At step 305, the method may include the server receiving an order over network 110 initiated by user 180a on user interface 170. The order may indicate the user profile sending the order, the target establishment, the user contact recipient, and one or more selections chosen by the user, message sent by the user, and payment information. The payment information is then submitted and confirmed (e.g. by server 140 in one exemplary embodiment) for processing of the payment. While server 140 is processing the payment, the appropriate systems or providers are contacted in order to complete the transaction and payment is transferred from user 180a to establishment 120a. If the payment successfully transfers from user 180a, a confirmation message may be displayed to the confirm the time of purchase and the total price charged as well as the approximate time the selections may be redeemed by user 180b. If payment is declined, a failure message may be displayed to the user 180a notifying user 180a of the reason for the failed transaction. After the transaction is completed, a digital receipt of payment may be stored in user profile database 142 and establishment profile database 144 in some embodiments.

At step 306, the exemplary method may include transmitting the order to establishment computing device 125 of the establishment 120a for presentation via order-fulfillment interface 128 to employees in order to fulfill the order. If establishment 120a has multiple establishment computing devices 125, the method may include displaying the order to multiple establishment computing devices 125 instead of just one or transmitting the order to a specific establishment computing device 125 of the multiple establishment computing devices 125 associated with a particular establishment 120 that would be responsible for providing selections on that specific the order. Establishment computing device 125 may have unique identification markers to enable establishment computing device 125 to be distinguished from one another to decrease confusion.

At step 307, the method may include verifying an order and estimating a time for completing the order by establishment 120a. The order fulfillment interface 128 may provide the employee or staff at establishment 120a an option to cancel the order, which is then received by the server 140, whereby server 140 cancels the order and sends a notification to user 180a. Order fulfillment interface 128 may also provide fields for the staff or employee to input the reason for the cancellation, which may be transmitted to server 140 and then to user computing device 185a to be displayed to user 180a through user interface 170 as well as recorded and stored in establishment profile database 144 for subsequent use.

An example for this situation to occur would be if establishment 120a no longer could fulfill the order because they lack the ingredients or because establishment 120a cannot fulfill the order for any other reason (e.g. establishment 120a will be closed when the order needs to be fulfilled). The cancellation message may then be transmitted to and displayed as a message through user interface 170 to user 180a, notifying user 180a the order has been cancelled and that their payment will be returned. The approximate time for completion may be estimate-based, at least in part, on prior pending orders existing at establishment computing device 125 and previous completion times for the exact or similar order. The approximate time of completion and designated pickup point in establishment 120a may be transmitted to server 140 over the network and then transmitted and displayed through user interface 170 to user 180a and 180b.

At step 308, the exemplary method may include user 180b arriving at designated pickup point and receiving the completed order. In one or more non-limiting embodiments user 180b may instead receive a notification that user 180a has ordered one or more selections for user 180b wherein user 180b may confirm they wish to receive the selections or choose to deny the order which terminates the process.

User 180b may verify the content of the order by comparing the content of the order on user interface 170 with the produced selections presented by establishment 120a. Completed delivery of the order by establishment 120a to user 180b may be verified, in one exemplary embodiment, by scanning an optical bar code, a QR code, a RFID tag, or other suitable identification technology displayed on user interface 170, which can automatically promote the status of the order to completed. This may be achieved using an optical bar code, a QR code, or a RFID tag reader connected to establishment-computing device 125 or other device on the network 110. In other embodiments, user 180b may be given a code sequence that when inputted into the appropriate field, the order fulfillment interface completes the order.

Another exemplary method may be that an employee or staff member at establishment 120a selects an appropriate button displayed on user interface 170 such as a redemption button after verifying the identity of user 180b by comparing user 180b to a picture of user 180b displayed on establishment computing device 125. Alternatively, or additionally, user 180b may be verified as the correct, intended recipient of user 180a's order by verifying that user 180b has a particularly displayed color or numerical sequence on user interface 170 that matches a color or numerical sequence displayed on order fulfillment interface 128.

In some embodiments, order fulfillment interface 128 may provide a cancellation button that may be used to cancel an order at any time and a verification button wherein they wish to proceed with delivering the order to user 180b. The ability to cancel an order may be used when user 180b is not of a certain age to redeem specific selections. The cancellation button and an associated cancellation process may be used to display an initiated order whereby staff or employee may individually select the specific selections to be cancelled if only one or more selections need to be cancelled while the rest of the order may remain intact.

At step 309, the exemplary method may include receiving a delivery confirmation displayed on user interface 170 to user 180a and user 180b in at least some examples. User 180a may choose to have a receipt or invoice sent to them as a printed receipt, via e-mail, text message, hyperlink, or other type of message connected to the server where a virtual image of the receipt is stored in the establishment database 144 and user profile database 142.

After completing an order, user interface 170 may display a survey to user 180b or the survey may be seen via email, text message or a link to a web site asking about the individual good or service in the order as well as the service provided by establishment 120a in completing the transaction. User 180b may give a rating of the selection according to any number of ranges including taste, presentation, visual appeal, and lasting effect. There many also may be one or more fields allowing user 180b to optionally input their own worded comments. The survey results may be made private, public, or accessible based on the privacy settings of user 180b. User interface 170 may include a transaction history button for displaying previously ordered and received selections displaying information such as the date, the establishment, the sender, the receiver, and if the order was terminated or completed.

In other non-limiting embodiments, user 180a may “check in” to an establishment 120a and user interface 170 may provide the option for user 180 to select their own profile using an appropriate button instead of another user. User 180a then may order any good or services from the list of selections and redeem the goods or services for themselves. User 180a then may provide verification to establishments 120, such as by providing a numerical code, color code, optical bar code, a QR code, a RFID tag, other suitable identification technology displayed on user interface 170 to redeem the goods or services from establishments 120, thus completing the order.

Server 140 may create an establishment location based social network among the users who have “checked in” into the same establishment. Users 180 (which may include, without limitation, user 180a and user 180b) in the social network may be conveyed to the user through a list or drop-down menu. Users 180 may select other users in the location based social network and order them goods or services from the selections of establishments 120 whereby the other user may redeem the order from the user. The social network may provide messaging capability between users. Messages may have one or more parameters, including information to be communicated to a user having images, text, photos, or other information provided by other users regarding the establishment. User interface 170 may provide users 180 the option to then accept or decline a message. In some non-limiting embodiments, the social networking application may restrict access to certain features, such as messaging, to users that are currently visiting the same physical location of the establishment.

User interface 170 may provide users 180 with the ability to set privacy parameters for the social network so that user's presence at a particular establishment may not be visible to other users 180, but rather is only visible with a predefined group of users 180, such as only to friends or family. Other considerations or parameters for displaying a user's presence at establishment 120 may alternatively, or additionally be implemented as desired by the user, such as displaying only to a certain age group or a specific gender or only displaying a user's location at establishment 120 at a specific time or day. For example, a user's 180 location may only be shared between 9:00 a.m. and 5:00 p.m. to ensure safety of the user who does not want to be visible to other users when it is night out. In some embodiments, a user 180 may not share their presence except for when the user 180 posts a content item within a predefined geographical area. For example, presence information of user 180 is only visible when the user in is Washington, but not if user 180 leaves the state.

FIG. 4 is a pictorial illustration of an exemplary scenario illustrating the above described system and method. Betty 410 has joined her group of friends for a night out on the town, starting at the “Construction Bar” 400, a bar known for its unique appeal of looking like a half -completed building. Betty 410 launches the social network ordering application and “checks in” to “Construction Bar” 400 using her smartphone. Betty 410 has set her privacy settings to be visible to any user also “checked in” to “Construction Bar” 400 and to enable communication with anyone she is friends with or that has purchased good or services at “Construction Bar” 400. Brian 420 notices Betty 410 across the room and decides to order a cosmopolitan drink to be delivered to Betty 410 via the online ordering system at which they are preregistered. Brian 420 using his smartphone, launches social network ordering application 175 on his smartphone (for example), scrolls through photos of the users “checked in” into the “Construction Bar” 400 and selects Betty 410's name seeing her picture. The social network ordering application 175 presents a menu of “Construction Bar” 400 where Brian 420 selects a cosmopolitan drink and adds it to the available shopping cart for purchase. Brian 420 provides payment using his credit card and adds a message to be sent to Betty 410.

Betty 410 receives a notification on her smartphone that Brian 420 has ordered her a cosmopolitan drink along with a message and a QR code. Betty 410 is notified that the cosmopolitan drink should be ready in one (1) minute. An employee or other service worker may receive notification of the order. Further, the employee or other services worker may receive notification that to redeem the order, Betty 410 must have a a specific QR code. The employee or other service worker then may gather the necessary ingredients to make a cosmopolitan and make the drink. Betty 410 presents her QR code to the employee or other service worker who scans the QR code, which is accepted. Once the cosmopolitan drink is delivered and everything is verified, Brian 420, Betty 410, and establishment receive notification that this order has been completed.

In some embodiments, Betty 410 and/or Brian 420 may be later sent a survey on the social network ordering application (e.g. social network ordering application 175) to receive information from the two about either the Construction Bar, the drink provided, and various other factors. These survey results may be shared with the Construction Bar, which may beneficially be useful in understanding how their customers feel about their goods and/or services. Brian 420 may also have the option to message Betty 410 now because of Betty's 410 privacy settings. Brian 420 messages Betty 410 who then responds and after a while they eventually decide to communicate with each other in person. If Betty's 410 privacy settings allowed for another user “checked in” into the Construction Bar to message her, then a user such as Brian 420 would not have to have ordered a good or service to message Betty 410.

In addition, user interface 170 may provide users 180 the ability to transfer funds to another user directly instead of sending particular goods or services if the other user is “checked in” into a location or not “checked in” into a location at the time. User 180 may select a contact from their contact list and select an appropriate button whereby a user may input an amount in an entry field to send to the contact. Users 180 may input their credit card information for a credit card in a credit card input field or can alternatively select some other form of payment transfer, such as, for example, PayPal or cryptocurrency wallet login credentials for payment. The payment information is then submitted and confirmed (e.g. by server 140) for processing of the payment. If successfully completed, the payment is transferred from user 180 to the intended contact whereby the contact may now use funds to pay for the order at a particular establishment (e.g. establishment 120). The contact is notified of the amount credited and user 180 is notified of successful delivery.

The following is an example of a scenario illustrating the above described system and method. Darryl, a teenage in high school is going out on his first date to a local sushi place named “Poke Pose” with Dye Ann, a classmate who he has a had a crush on for over a year. Sadly though, Darryl does not have much in the way of funds and spent his monthly allowance on video games. Darryl's parents decide to help Darryl out by chipping in to pay for Darry and Dye Ann's meal at “Poke Pose.” Darryl launches the social network ordering application (e.g. social network ordering application 175) and “checks in” to “Poke Pose” using his smartphone (e.g. user computing device 185a). Darryl's parents, also using their smartphone (e.g. user computing device 185b), launch social network ordering application 175 on their smartphone, and selects Darryl's name and an amount (e.g. $100) to send to Darryl, which they then pay for. Darryl receives a notification on his smartphone that his account has been credited with $100. Darryl's parents are notified that the credit was delivered. Darry is now able to use this credit to pay for him and Dye Ann's meal at “Poke Pose.”

In some embodiments, server 140 may analyze and calculate data stored in the databases whereby user interface 170 may display collected results from user profile database 142 from server 140 in the form of ranking leaderboards among the users 180 based on any number of parameters, including most orders in the month, most orders at a specific establishment 120, most orders of the same good or service, most establishments 120 ordered from, most users 180, whereby establishment 120 or social network ordering system 100 may incentivize users 180 on the leaderboards with advertisements, promotions, or notifications directed to attracting users 180.

Using this system and method provides a unique way for users 180 to purchase goods or services for themselves or another user at various establishments 120 that the users 180 have “checked in” into as well as to send funds that may be used in social network ordering application 175. Users 180 may also communicate with other users through social network ordering application 175 if users 180 are at the same establishment 120 or venue and the privacy parameters of the users allow for communication. Alternatively, users 180 (who are part of a shared network of users subscribed to social network ordering application 175) may send messages to another regardless of whether they are located in the same establishment or not.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the use contemplated.

What is claimed is:

1. A method for completing an order, comprising:
receiving, by a social network ordering system, an order over a network initiated by a first user using a first user computing device, the order indicating an establishment, the order comprising one or more selections of goods, services, or a combination thereof that are available at the establishment, the social network ordering system having one or more processors; one or more memory devices coupled to the one or more processors; and one or more computerized programs, wherein the one or more computerized programs are stored in the one or more memory devices and configured to be executed by the one or more processors, the one or more computerized programs including instructions;
directing, by the social network ordering system, the order to an establishment computing device for the establishment or agents of the establishment to retrieve the one or more selections; and
delivering, by the social network ordering system, a redemption code to a second user computing device of a second user, the redemption code redeemable for the one or more selections from the establishment.

2. The method of claim 1 further comprising:
confirming, by the social network ordering system, delivery of the order to the second user.

3. The method of claim 2 further comprising:
determining, by the social network ordering system, if the order from the second user is to be processed and delivered immediately or at a predetermined in the future;

4. The method of claim 3 further comprising:
receiving the order further comprising receiving an electronic payment for the order.

5. The method of claim 4 further comprising:
presenting, by the social network ordering system, a menu of the one or more selections to the first user, allowing the first user browse and select the one or more selections provided as possible selections that are associated with the establishment.

6. The method of claim 5 further comprising:
verifying, by the social network ordering system, the second user, by scanning of the redemption code wherein the redemption code is verified the status of the order to promoted to completed.

7. The method of claim 6 further comprising:
determining, by the social network ordering system, a preparation estimated time, the preparation estimated time representing a time based, at least in part, on prior pending orders existing at establishment previous competition times for the exact or similar order.

8. The method of claim 7 further comprising:
sending, by the social network ordering system, a data request to second user computing device, for identifying a geographic location of second user computing device or a network location of second user computing device, as well as a timestamp identifying when the request was transmitted to the second user computing device.

9. The method of claim 8 further comprising:
receiving, by the social network ordering system, a self reported positioning location of the second user at an establishment; and
presenting, by the social network ordering system, the self reported positioning location of the second user to the first user.

10. The method of claim 9 further comprising:
displaying, by the social network ordering system, the self reported positioning location a map with the second user displayed as an identifier at the establishment.

11. The method of claim 10 further comprising:
presenting, by the social network ordering system, collected results in the form of ranking leaderboards among the users based on any number of parameters including most orders in the month, most orders at a specific establishment, most orders of the same good or service, most establishments ordered from, or most users.

12. The method of claim 11 further comprising:
generating, by the social network ordering system, an establishment location based social network among the users that social network ordering system has received self reported positioning locations at an establishment wherein users in the establishment location based social network are capable of ordering goods or services for other users in the location based social network.

13. The method of claim 12 further comprising:
obtaining, by the social network ordering system, privacy parameters of the users in the establishment location based social network, wherein privacy parameters allow the user's presence to be visible only to a predefined group of users only at a specific time or day.

14. A social network ordering system comprising:
one or more databases coupled via a network;
one or more processors coupled to the one or more databases; and
at least one computing device coupled to the one or more processors and the one or more databases via the network; wherein the one or more processors are configured to:
receiving, by the social network ordering system, an order over a network initiated by a first user using a first user computing device, the order indicating an establishment, the order comprising one or more selections of goods, services, or a combination thereof that are available at the establishment;
directing the order to an establishment computing device for establishment or authorized users at the establishment to retrieve the one or more selections;
delivering a redemption code to a second user using a second user computing device, the redemption code redeemable for the one or more selections from the establishment; and
confirming delivery of the order to the second user.

15. The social networking system of claim 14, wherein the processors are further configured to: receiving a self-reported positioning location of the second user at an establishment;
presenting the self-reported positioning location of the second user to the first user, displaying the self-reported positioning location on a map with the second user displayed as an identifier at the establishment.

16. The social networking system of claim 15, wherein the processors are further configured to: generating an establishment location based social network among the users that have self-reported their positioning locations at an establishment wherein the users in the establishment location based social network are capable of ordering one or more selections for other users in the establishment location based social network.

17. The social networking system of claim 16, the establishment location based social network further comprising privacy parameters of the users in the establishment location based social network, wherein privacy parameters allow user's presence to be visible only to a predefined group of users only at a specific time or day.

18. The social networking system of claim 17, the establishment location based social network further comprising a communication interface wherein the communication interface is configured so that the users are allowed to communicate with other users in the establishment location based social network.

19. The social networking system of claim 18, wherein the processors are further configured to: determining a preparation estimated time, the preparation estimated time representing a time based, at least in part, on prior pending orders existing at the establishment previous completion times for the exact or similar order

20. The social networking system of claim 19, wherein the processors are further configured to: verifying the second user by scanning of the redemption code wherein the redemption code verifies the status of the order from promoted to completed.
